(19) United States
(12) Patent Application Publication
(10) Pub. No.: US 2018/0060381 A1
(43) Pub. Date: Mar. 1, 2018

(54) SYSTEMS, APPARATUSES, AND METHODS FOR ANALYZING AND MAINTAINING DATASETS

(71) Applicant: Hyperfish, Inc., Kirkland, WA (US)

(72) Inventors: Brian Cook, Bellevue, WA (US); Chris Johnson, Woodinville, WA (US)

(21) Appl. No.: 15/689,920

(22) Filed: Aug. 29, 2017

Related U.S. Application Data
(60) Provisional application No. 62/380,797, filed on Aug. 29, 2016.

(51) Int. Cl. G06F 17/30

(52) U.S. Cl. CPC G06F 17/30371; G06F 17/3056

(57) ABSTRACT

Examples of methods, systems, and computer-readable media for completing, updating, and maintaining structured or unstructured datasets, including data stored in a structured relational database, unstructured database or line of business system such as a directory service, a Customer Relationship Management database, or other structured or unstructured data source. In some examples, administrators specify a dataset to be maintained and definitions for the data of the dataset to follow. A computer system programmed for maintaining datasets analyzes the dataset and applies the specified definitions. If there is data that does not conform, that data is flagged for attention. The computer system then searches internal and external data sources to find examples of correct data to provide suggestions to users. The computer system then contacts a user through a communication channel to start an automated dialog with the user. The system asks for confirmation of the suggested data or for the user to supply appropriate data. The system updates the dataset based on the user's response.

### CROSS-REFERENCE TO RELATED APPLICATION(S)

This application claims priority to U.S. Provisional application No. 62/380,797 filed Aug. 29, 2016, which is incorporated herein by referenced, in its entirety, for any purpose.

### BACKGROUND

Databases and datasets, such as Microsoft SQL Server and Customer Relationship Management databases, are foundational to the information management of many businesses. Databases can be used to store a variety of information ranging from user information to sales information to other information. Keeping an organization's databases up to date with quality information can be important, but many databases are out of date and missing critical information. Technology projects such as personalized portals, cloud migration, and mobile intranet, can fail due to poor data quality. Existing techniques for maintaining an organization's databases rely on users to consciously realize something is out of date and then request updates to the data, but this can be unreliable. There remains a need for new products and techniques that provide for an improved approach to data maintenance.

### SUMMARY

Technologies are generally described that include methods, systems, and non-transitory computer readable media. Disclosed examples can be relevant to improving technology for computing devices programmed to complete, update, and maintain datasets, such as data stored in a directory service.

In an example, system administrators specify a dataset for a computing system to complete, update, or maintain. The administrators further specify definitions for the data of the dataset to follow, such as data format, data type, rules, and other definitions. The system analyzes the dataset and applies the specified definitions. Data that does not conform to the definitions is flagged for follow up attention. The system may then search internal and external data sources to find examples of correct data that can be used to provide suggestions to end users regarding the flagged data. The system then contacts a person responsible for the flagged data using a communication channel (e.g., email or instant message) to start a dialog with the user in an automated manner. Using the dialog, the system asks for confirmation of the suggested data or asks the user to supply appropriate data. The system then updates the dataset based on the user dialog. Information can be organized using a tracking module to identify what data has been asked about and what data is still needed.

In an example, the system can select the communication channel by identifying how a user prefers to respond. These user preferences can be generated by tracking how a user responds to messages. In this manner, the system can learn what channels, times, and dates are effective for corresponding with the user. The system can further use a suggestion engine to generate suggestions regarding the noteworthy data by scouring data sources, such as the user's email inbox, social media presence, and other sources. These suggestions can be used during the dialog with the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an illustration of an example system that may be used to maintain datasets according to examples described herein.

FIG. 2 is an illustration of an example user interface for viewing or modifying definitions according to examples described herein.

FIG. 3 is an illustration of an example analysis record according to examples described herein.

FIG. 4 is an illustration of an example communication via an email communication channel in accordance with examples herein.

FIG. 5 illustrates an example conversation via an instant message communication channel according to examples described herein.

FIG. 6 is a flowchart illustrating an example process for maintaining a dataset according to examples described herein.

FIG. 7 is a schematic illustration of an example computing system arranged according to examples described herein.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known software operations, computer system components, circuits, control signals, and timing protocols, are not shown in detail in order to avoid unnecessarily obscuring the described embodiments of the invention.

Examples herein may be applicable to improvements in technologies for completing, updating, and maintaining structured or unstructured datasets, including data stored in a directory service or database.

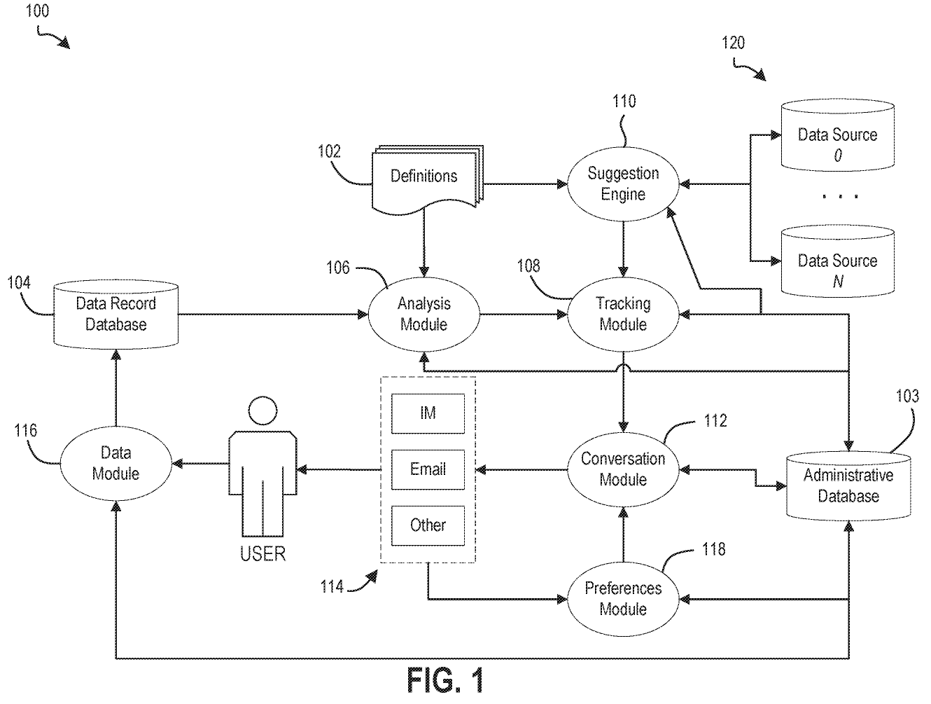

FIG. 1 illustrates an example of a system that may be used to maintain datasets. In some examples, the system includes definitions 102, an administrative database 103, a data record database 104, an analysis module 106, a tracking module 108, a suggestion engine 110, a conversation module 112, communication channels 114, a data module 116, a preferences module 118, and data sources 0-N 120. Each of the modules described herein may be implemented using all or a portion of a computing system. Multiple modules may be implemented on a same computing system and/or different modules may be executed by different computing systems. Generally, each of the modules may be implemented by software executed by one or more processor units. The software may include one or more computer readable media encoded with instructions which, when executed, cause the one or more processor units to perform the functions of the modules as described.

The definitions 102 may be a group of one or more data definitions, rule definitions, or other definitions used for correcting data in a structured dataset. The definitions 102 may be stored in a database or other data structure. In an example, a definition of the definitions 102 may define a rule for formatting telephone numbers, dates, names, and other information. For example, a definition may specify a regular expression describing the form of a valid email address, a particular date format, a particular telephone number format, or other information. In another example, a definition may define permissible and impermissible characteristics for a user profile picture. For instance, there may a definition of invalid profile pictures as blank pictures, low resolution pictures, pictures that do not include a human face, pictures of two or more people, or pictures containing nudity. There may also be definitions that flag old data. For example, there may be a definition stating that data that has not been verified in over a year should be re-verified.

The definitions 102 may further include user preferences or settings for maintaining the data record database 104, in an example, these preferences or settings include the location of the data record database 104 and the appropriate security credentials needed in order to connect and query the data record database 104. The preferences or settings may further include how frequently the data record database 104 should be analyzed, such as once per day or on an ongoing basis.

The data record database 104 may be implemented using any of a variety of datasets, structured and/or unstructured, which may be maintained and/or augmented using techniques described herein. Examples of datasets include, but are not limited to, data stored in a structured relational database, unstructured database, or line of business system such as a directory service, a Customer Relationship Management database, or combinations thereof. In some examples, rather than storing the underlying data or each data record, the data record database 104 stores links or pointers (e.g., or similar structure) to a respective master data record, which may be located within in the data sources 0-N 120, for each particular data item within the data record.

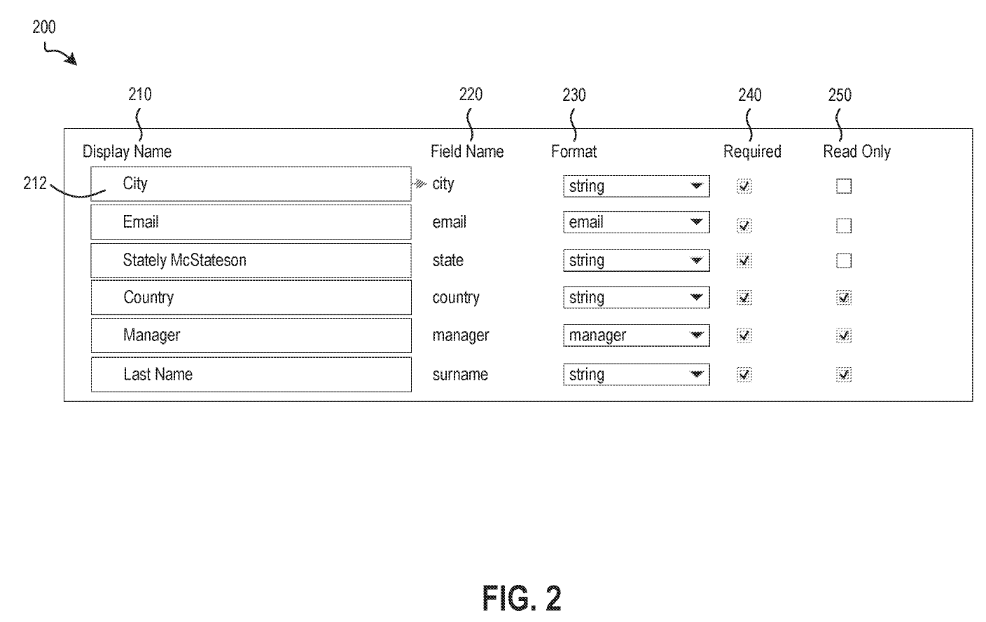

FIG. 2 illustrates an example user interface 200 that the system 100 may present to an administrator of the system 100 for viewing or modifying the definitions 102. The example user interface 200 includes a display name 210, a field name 220, a format 230, a required Boolean 240, and a read only Boolean 250 for each definition of the definitions 102. The first definition 212 in the example user interface 200 is for information regarding a user's city. The display name information may specify how the city information is described to the user. (e.g., a contact card of an email application may display “City—Seattle”). The field name 220 information may be the name of the field as it is referred to by the system 100 (e.g., a one or more of the data sources 0-N 120 may include a record that includes a field called “city”). The format 230 may specify how the information is formatted (e.g., the city information is formatted as a string). The required Boolean 240 may specify whether or not the information is required of a user. For example, the user's organization may require that the data record database 104 include the user's city but not the user's fax number, so the required Boolean 240 for the city definition may be set as true to indicate that city information is required, but a fax number definition may have its required Boolean 240 set to false. The read only Boolean 250 may indicate whether the data is editable by general users or whether heightened permissions are required to modify the information. For example, an organization may allow users to modify their city information, but the organization may not want users to be able to modify information specifying his or her manager. Accordingly, the organization may set the read only Boolean to true for the manager information but set the read only Boolean to false for the city.

Returning to FIG. 1, individual data records included in the data record database 104 may include a set of data or a set of links or pointers to data in the data sources 0-N 120, such as a directory or database that the system 100 may act on. For example, a data record of the data record database 104 may include information from a database or dataset from systems such as MySQL, Microsoft SQL server, Oracle, Microsoft Active Directory, Microsoft Azure Active Directory or a customer relationship management system. Components of the system 100 may connect to the data record database 104 using a web service or a database connection protocol from a database vendor. The data record database 104 or associated components may provide the system 100 or components thereof with operations to create, read, update, and delete data records stored at the data record database 104 and/or data stored at the data sources 0-N 120. The data record database 104 can support the ability to query data records of the data record database 104 for data items that have changed or been added/removed since a particular date and time or since the last time a respective data record of the data record database 104 was queried. The analysis module 106 may use this change information for incremental analysis. For clarity, the foregoing will discuss data records of the data record database 104 in terms of the underlying data being stored at the data record database 104. However, as previously discussed, the discussion also applies to implementations where the underlying data is stored and maintained in the data sources 0-N 120, and the data record database 104 only stores links or pointers to that underlying data.

The administrative database 103 may include a respective state record for each data record stored at the data record database 104 that tracks state information associated with the corresponding data record. For example, a state record of the administrative database 103 may include information related to management of the corresponding data record. The management information may include modification history, a state of each of the data items in the corresponding data record (e.g., update state for missing or incorrect data or approval state waiting for updates to be approved, etc.), analysis history of the corresponding data record (e.g., by the analysis module 106), tracking records (e.g., by the tracking module 108). In some examples, the administrative database 103 may also store communication records associated with users and approvers, which are used by the tracking module 108 or the conversation module 112 to select a user or approver, a conversation method for the user or approver, and a conversation time for the user or approver. In other examples, the communication records may be stored in a separate database from the database storing the state records.

The analysis module 106 may be a module that connects the system 100 to the user and applies the definitions 102 to identify data that is missing or invalid (e.g., one or more erroneous data item) in a data record of the data record database 104. In an example, the analysis module 106 connects to the data record database 104 and queries for data of a data record. As the analysis module 106 receives data from the data record database 104, the analysis module 106 applies the definitions 102 (or a set or subset of the definitions 102) and checks the received data against the definitions 102. If a data item is found to not pass a definition (e.g., a definition specifies that city information is required, but a user's entry in the data record database 104 does not include city information), the system may generate an exception describing the failing of the rule (e.g., describing which data of which user failed which rule) or take another action. For example, the system may store analysis records in a corresponding state record of the administrative database 103 that describe the data of the data record that did not pass the definition and a reference to the definition that it did not pass. The analysis module 106 may conduct varying levels of analysis ranging from full analysis (e.g., analyzing substantially all of the data in the data record database 104) to incremental (e.g., analyzing newly updated or added information since the last time analysis module 106 conducted an analysis).

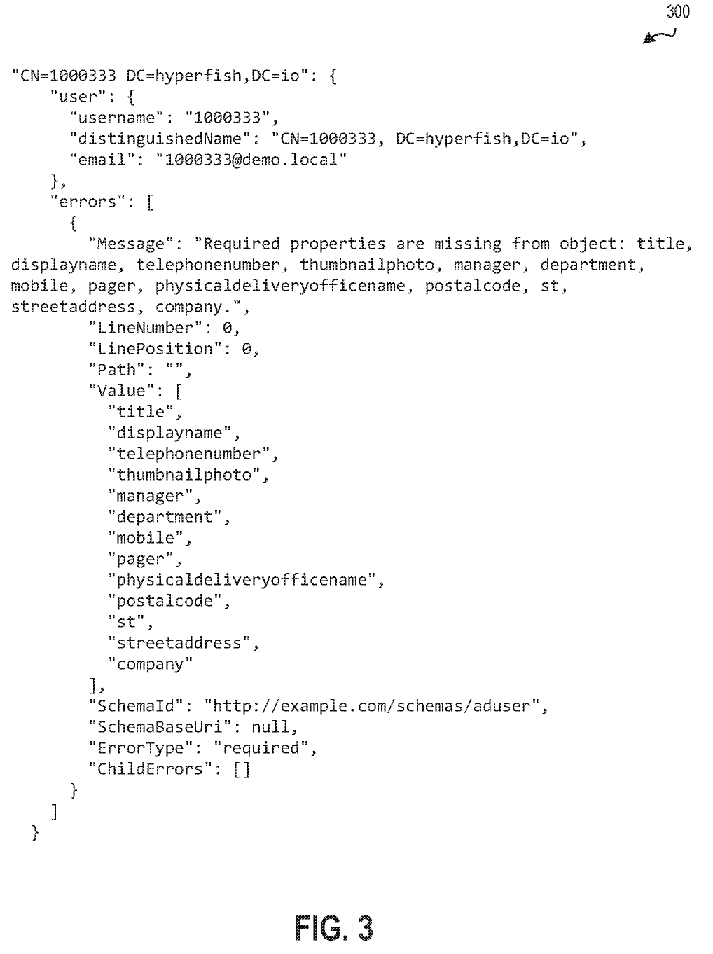

FIG. 3 illustrates an example analysis record 300. The analysis record 300 shows that there is an error regarding the user with the common name “1000333” of the organizational unit “hyperfish” and domain component “io”. In particular, the example analysis record 300 indicates that certain required properties (e.g., information where the value of the required Boolean is “true”) are missing. The record 300 includes a list of the values (e.g., the field names of the values) that are missing.

Returning to FIG. 1, the analysis module 106 may additionally query the tracking module 108 for data of a data record that previously did not pass the definitions 102 and checks those items for compliance. If those items are now found to be in compliance, those items may be flagged as now passing and a passing analysis record may be created for them. The passing analysis record may have a similar format to the example analysis record 300, and may be stored at the corresponding state record of the administrative database 103. During or after the analysis of the data record database 104, the analysis module 106 may pass the resultant analysis records to the tracking module 108 for action.

The tracking module 108 may track analysis records produced by the analysis module 106. The tracking module 108 keeps track of which data items are in compliance and which ones are out of compliance with the definitions 102. In an example, the tracking module 108 can tag them with appropriate data suggestions from the suggestion engine 110, which can append potential suggestions for the user that suggest how to complete the data. When passing analysis records are received from the analysis module 106 or from the administrative database 103, those items are marked complete in the administrative database 103.

When analysis records are received, the tracking module 108 may send them to the conversation module 112. Receipt of the analysis records at the conversation module 112 may indicate that the conversation module 112 should start, or stop, a conversation with the user associated with the data item. For example if a data item was previously out of compliance but is now compliant, then the tracking module 108 may signal to the conversation module 112 that the conversation module 112 no longer needs to alert the user to supply the missing or incorrect data.

The suggestion engine 110 searches the data sources 0-N 120 for potential data item updates and stores those suggestions. The data sources 0-N 120 may be located within a single platform or system, or may be spread across multiple platforms and systems having multiple protocols for accessing data within the respective data source 0-N 120. For example, the suggestion engine 110 can be connected to Microsoft's Exchange Online email platform, and the suggestion engine 110 can detect when a user updates their email signature with a new phone number. The suggestion engine 110 may then record the change as a possible suggestion for that user in data items that contain the user's phone number.

In an example, the suggestion engine 110 runs in the background and watches for or is alerted when data from the data sources 0-N 120 changes, and the suggestion engine 110 records the changes. The definitions 102 can be configured to connect to a data point from one of the data sources 0-N 120 to a particular data property to ensure suggestions are made for the appropriate properties. For example, an administrator of the system 100 can configure a definition such that that phone number changes in a person's email signature results in phone number suggestions for the “phoneNumber” property in the data record database 104.

The suggestion engine 110 can augment any existing analysis results with suggestions of data that could fix the issue. The suggestion engine 110 can generate new analysis records for data that has changed in a connected system, but for which there is no existing analysis record. For example when a user's profile photo changed in a social media website, the suggestion engine 110 can create a new analysis record for a user data item suggesting that they update their photo with the one from the social media website. The newly created analysis record by the suggestion engine 110 may be stored in the corresponding state record of the administrative database 103.

The conversation module 112 may be configured to communicate with users. The conversation module 112 can do so by keeping track of the state of the conversation with a user and deciding how to best contact the user.

The conversation module 112 may receive data from the tracking module 108 regarding particular information to retrieve to complete or correct a data item. The tracking module 108 may decide how best to connect with the user based on any previous interactions with the user. Historical contact and response information may be retrieved from the communication record of the administrative database 103 corresponding to the user. For example, if a user in the past has replied in a timely manner via email at 10:00 a.m. then the tracking module 108 may use that information to apply a weight to that channel as a potential mechanism for communicating with the user. The tracking module 108 may do this for all of the configured communication channels 114.

The conversation state may be stored in the corresponding state record or the corresponding communication record (associated with the user) of the administrative database 103. The conversation module 112 may keep a communication record to track each user it interacts, along with a history of those interactions. The communication record may include the date and time of the interaction, the channel of communication (e.g., email, instant message, or another communication channel), and the topic that was included in the communication. When replies from the recipient are received those are also catalogued in the communication record. The conversation module 112 uses this history of interaction with users to score (e.g., provide one or more availability score, such as one per available communication channel) indicating which user is most likely to respond during a particular period of time of day, on a particular date and time, and via which communication channel. This availability score may be provided to other modules in the system 100. For example, the data module 116 may request the availability score to compute the list of approvers for an update. Additionally, the conversation module 112 may use the score when computing the mostly likely channel of success for communicating with a given user.

In a specific, non-limiting example, the score may be computed by: 1) Evaluating all pervious responses from a user for a time of day in any given working day, and if a user has responded in that time period of a working day in the past via a communication channel, then that particular communication channel is weighted higher than another in the system where no response has been received. 2) For each communication channel the conversation module 112 queries the channel for the users current status (e.g., out of office, away, offline, busy, in a meeting, etc.), and if the communication channel indicates that the user is currently online, then the score for that communication channel is increased; and if not, then a score is decreased; 3) If there have been communications with a user's peers (e.g., based on an indicated direct organizational team and preferred time zone), then scores may be computed for each of those peers as per #1 and #2 above, and those scores may be weighted and added to the current score for a particular communication channel for the user (e.g., this may be repeated for multiple levels of the organization hierarchy), and 4) a final availability score for each communication channel is computed. The conversation module 112 may initiate a communication based on the communication channel having a highest availability score.

The conversation module 112 may select a communication channel based on the applied weightings and initiate the conversation with the user over the selected communication channel. When the conversation module 112 initiates the communication, the conversation module 112 may keep track (e.g., in a communication record) when the communication was sent and other information regarding the communication. Based on settings configured in the system 100, if the user does not respond the conversation module 112 may send a reminder to the user by selecting a communication channel again and sending a reminder to the user (e.g., repeating the request for information). This reminding may go on indefinitely depending on the configuration options in the system, or in some examples, after a predetermined number of attempts, a different communication channel may be selected. The communication channels 114 are mechanisms for sending or receiving communications from a user via a particular mechanism such as email, text message, or instant message. Each communication channel has the ability to hold a conversation with the user via that channel.

For example, an email communication channel can send an email to the appropriate user with an appropriately worded question based on system settings and the information in the analysis record regarding what data is out of compliance. The email may tell the user what data is missing and that the user needs to provide the data. Then when the user replies to the email, the email communication channel receives the reply. The email communication channel or conversation module 112 can apply a natural language parser and machine learning to the user's reply to deduce what answers the user supplied. If successful, the communication channel or conversation module 112 may send a notification to the data module 116 that the user provided the appropriate answer.

The instant message communication channel can have a similar approach as the email communication channel, but given the real time nature of the communication with the user, the instant message communication channel can answer replies to instant messages substantially immediately. The instant message communication channel can also ask the user a series of questions over instant message to retrieve the data from them. The communication channels may be designed in a pluggable manner so that as new communication channels are introduced, they can be added to the system.

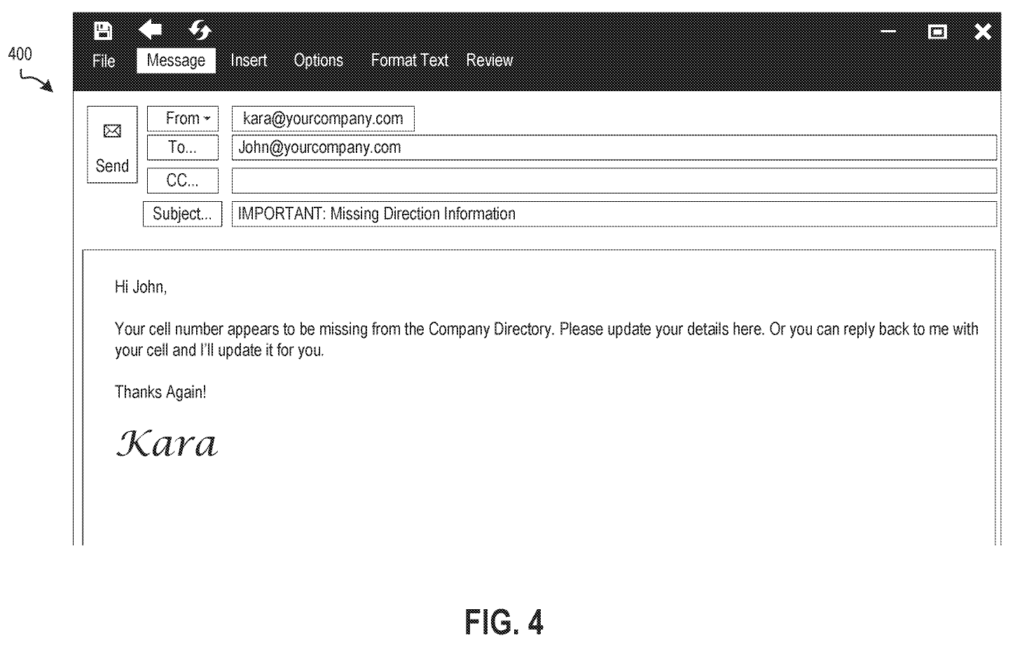

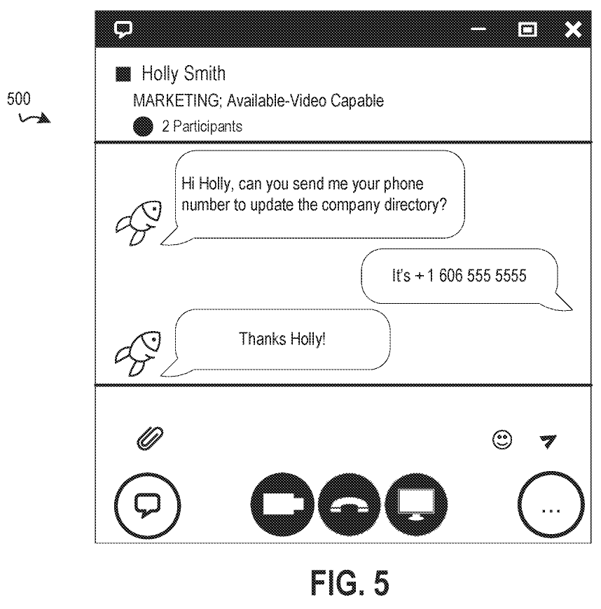

FIG. 4 illustrates an example communication 400 via an email communication channel. The communication 400 requests information regarding the user's cell phone number. The communication 400 provides the user the ability to supply the information at a provided hyperlink or by replying to the email, FIG. 5 illustrates an example conversation 500 via an instant message communication channel. The conversation 500 includes a request from the conversation module 112 to the user regarding the user's cell phone number. The user provides the cell phone number and the conversation module 112 responds by thanking the user.

Returning to FIG. 1, the data module 116 takes the completed data from the users via the communication channels 114 when the completed data is provided. Based on configuration settings the data module 116 can take a variety of actions, including writing the data back to the data record database 104 substantially immediately or storing the data in a database associated with the data module 116 for further processing. When writing data back to the data record database 104 substantially immediately, the data module 116 can connect to the data record database 104 and issue an update command for that system to send the data record database 104 the new data. When storing the data in a database for further processing, the data module 116 may store the new data in a database. The data module 116 may flag the data for future follow up, such as by setting a flag indicating that the data needs approval from a system administrator. The data module 116 or other component of the system 100 can alert the administrator of the flagged data (e.g., by email or other alert). The system administrator can then use the system to approve/reject the particular data item changes. If approved, the data module 116 may then write the data item back to the data record database 104. If rejected an appropriate email may be sent to the user informing them of such. In some examples, the temporary storage of data may be stored in the corresponding state record of the administrative database 103, including status of the data, source of the data, etc. The data module 116 may also record actions taken regarding updating a data record of the data record database 104, and may add information related to steps that have been taken to retrieve or update a data record and/or identify additional steps that still need to be taken. In some examples, update state indicated in the state record may indicate that the data record is waiting for a user update. The state record may also include an approver state, which indicates that an update to the data record is pending approval from an authorized person (e.g., an approver).

The communication records may store user and approver history and current use status (e.g., online, away, in a meeting, busy, out of the office, etc.), and may weight communication times and/or selection of an approver from a list of possible approvers based on this information. For example, each approver may be weighted according to whether the approver has been defined by the administrator user set for the particular data record attribute, whether the approver is someone that has decision-making authority over the user or update of the underlying data, an approver's an availability score, etc. The criteria may be weighted to select a specific approver or a subset of approvers, which may be sent to the tracking module 108 or the conversation module 112 to imitate and track an approval process.

In a specific, non-limiting example, rules defined for the data record indicate that when a record's property X is updated, user A, user B and user C are to be approvers, and additionally, the defined rules indicate that when property X is updated, the submitting users Manager should be an approver. The following evaluation takes place in real time: 1) users A, B and C are added to the approvers list with a weighting of 100; 2) the submitting user's manager, manager D, is added to the approver list with a weighting of 100 and users A, B and C weightings are adjusted to 80 each (e.g., because they are not direct supervisors); user A's availability score is 10, and so his/her weighting is adjusted to 90, user availability score is −10, so his/her weighting is adjusted to 70, user C's availability score is −10, so his/her weighting is adjusted to 70, manager D's availability score is 0, so his/her weighting is not adjusted; and 4) based on the weightings of 70 or lower, user B and user C are discarded, and user A with a score of 90 is kept, and Manager D, with a score of 100, is kept. Therefore, in this example, user A and manager D are the approvers for the data record update.

The preferences module 118 may be a module configured to learn about a user's preferences, such as communications preferences. In an example, as the communication channels 114 communicate with users, notifications are sent to the preferences module 118 to alert the preferences module 118 of events such as a user replying to an email or instant message. These events are logged in the communication record of the administrative database 103 and are then used to compile suggestions on the best time to contact users via various communication channels 114. For example the preferences module 118 may provide data to the conversation module 112 regarding the best times to contact a particular user via email, instant message, or other communication channels 114. The conversation module 112 may use these data points to weight the best communication channel 114 to use to contact the user. The data points may be based on aggregate user data (e.g., entire set of users, sub groups of users by geographic location, department, job function, etc.), user data specific to the user associated with the data record, or a combination of both.

The data sources 0-N 120 may be connected databases other configured systems data sources. The connected systems can be a database or other data repository on the internet, such as a web service or application such as a social media website. For example, the data sources 0-N 120 may be located within a single platform or system, or may be spread across multiple platforms and systems having multiple protocols for accessing data within the respective data source 0-N 120.

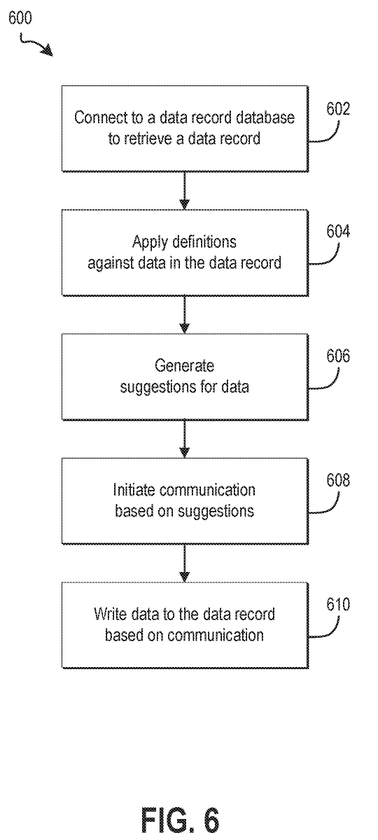

FIG. 6 illustrates an example process 600 for maintaining a data record. An example process may begin with block 602, which recites “connect to a data record database to retrieve a data record. “Block 602 may be followed by block 604, which recites “apply definitions to data in data record. “Block 604 may be followed by block 606, which recites “generate suggestions for data, “Block 606 may be followed by block 608, which recites “initiate communication based on suggestions. “Block 608 may be followed by block 610, which recites “write data to the data record based on communication.”

Block 602 recites “connect to a data record database to retrieve a data record. “In an example, during the process 600 the system 100 connects to the data record database 104, such as through a web service or a database connection protocol from a database vendor. The system 100 may connect to the data record database 104 using settings or parameters specified in the definitions 102, which may specify the location of the data record database 104 and the appropriate security credentials needed in order to connect and query the data record database 104. With a connection to the data record database 104 established, the system 100 can interact with the data record database 104 including applying the definitions 102 to data stored in the data records of the data record database 104 (e.g., as described in block 604). Block 602 can further include retrieving information about the data record database 104 from an administrator of the system 100.

Block 604 recites “apply definitions to data in the data record. “In an example, the system 100 applies definitions 102 to data in the data record of the data record database 104. This can include reading data from the data record database 104 regarding user information specified in the data record database 104, such as by querying the data record database 104 for one or more users or for information regarding one or more users. The definitions 102 may then be applied against the retrieved data. If a portion of the retrieved data is found to be non-compliant with a definition of the definitions 102, then an analysis record describing the non-compliance can be generated.

In an example, the system 100 may retrieve a user's complete data record as stored in the data record database 104, and the definitions 102 are applied against this record. The record may include information such as the user's last name, city, state, country, email address, and manager, among other information. These various pieces of information may be required and if the system 100 determines that they are not present for the user, then an analysis record describing this missing information may be generated.

Block 604 can further include retrieving or generating the definitions 102. For example, the system 100 may present a user interface to an administrator of the system 100 for specifying one or more definitions 102.

Block 606 recites “generate suggestions for data. “In an example, the suggestion engine 110 may generate suggestions for data. The suggestions may be related to an analysis record generated in block 604, the suggestions may be separate from an action record, or may be a combination thereof. The suggestions and the analysis record may be stored in a corresponding state record of the administrative database 103. In an example, the suggestion engine 110 may receive an analysis record indicating that particular information is missing from a user's record in data record database 104. The suggestion engine 110 can then access data sources 0-N 120 to retrieve information based on the analysis record. For example, the analysis record may indicate that a user's record is missing the user's current job title, the suggestion engine 110 can access a social network site, such as LinkedIn, to retrieve information relating to the user's current job title. Using this retrieved information, the suggestion engine 110 can generate a suggestion for the user's job title data.

Block 608 recites “initiate communication based on suggestions. “The system 100 contacts a person responsible for data via a number of configurable channels such as email or instant message and starts a dialog with the user in an automated manner to ask them for confirmation of the suggested data or for the person to supply the appropriate missing data. The person responsible for the data need not be the user and instead may be another person knowledgeable about the data or suggestion. For example, one of the user's social media pages may list the user's job title, but that information may be based on the user's own perception of their job title, so the conversation module 112 may contact the user's manager, a member of the user's organization's human resources department, or another person knowledgeable about the suggestion, in addition to or instead of the user. In another example, the suggestion engine 110 may contact multiple people regarding the information. For example, the suggestion engine 110 may first contact the user regarding the suggestion (e.g., to ask about whether the suggestion accurately reflects their job description) and then contact the user's manager or another person knowledgeable about the information for confirmation. In this manner, the suggestion engine 110 can filter out inaccurate data by first communicating with the user about the data and then following up with another person for confirmation. The conversation module 112 can select an effective communication channel from the communication channel 114 using the preferences module 118. The conversation module 112 may update the corresponding state record of the administrative database 103 to document all communication associated with the data record.

Block 610 recites “write data to the data record based on communication, “The data module 116 can take the information from the communications in block 608 and apply the data to the data record of the data record database 104. For example, the conversation module 112 may have confirmed the user's job title and provided this data to the data module 116 for updating the data record database 104. Data may be written to the data record database 104 substantially immediately (e.g., the data module 116 can connect to the data record database 104 and issue an update command) or the data may be stored for further processing or later use. For example, when storing data for later use, data module 116 may store the new data in a database and flag the data as needing approval from a system administrator. The data module 116 may then cause the administrator to be sent an email alerting them of the data pending approval. If the system 100 receives approval, the data module 116 may then write the data item back to the data record database 104. If rejected, an appropriate email may be sent to the user informing them of such.

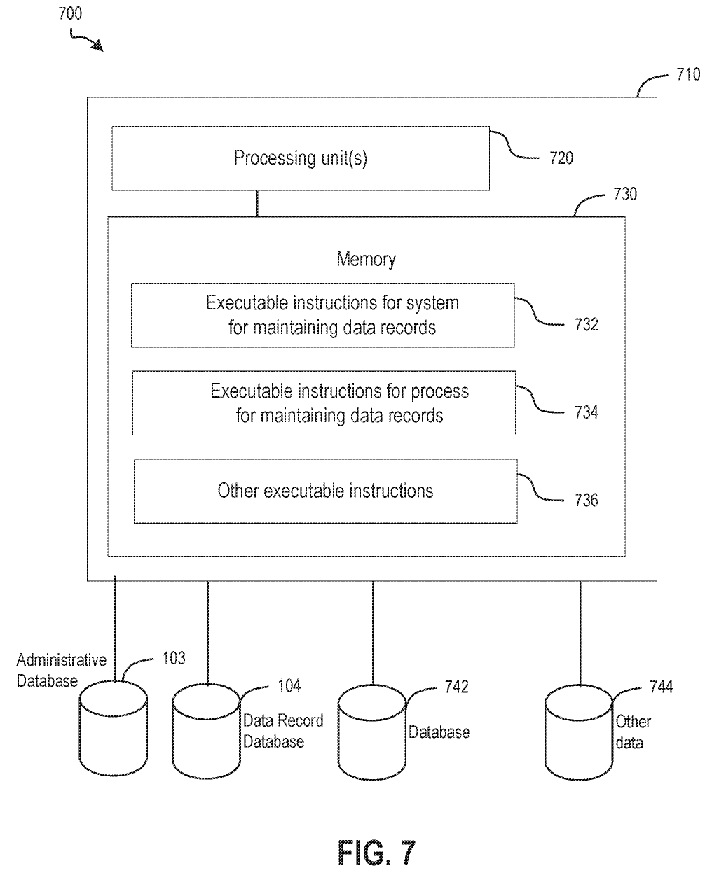

FIG. 7 is a schematic illustration of a computing system arranged in accordance with examples described herein. Computing system 700 includes computing device 710, which may include processing unit(s) 720 and memory 730. Memory 730 may be encoded with executable instructions for a system for maintaining data records 732, executable instructions for a process for maintaining data records 734, and/or other executable instructions 736. The computing device 710 may be in communication with electronic storage for the data record database 104, a database 742, and/or other data 744. The database 742 may be a data storage location for the components of the system 100. For example, the database 742 may be at least partially configured as the administrative database 103, a tracking database for tracking analysis records received from the analysis module 106, etc. The computing device 710 may be programmed to (e.g., include processing unit(s) and executable instructions to) provide one or more of the processes and systems described herein.

For example, the computing system 700 of FIG. 7 may be used to implement the system 100 of FIG. 1 and the process 600 of FIG. 6. The executable instructions for a system for maintaining data records 732 may include instructions executable on the processing unit(s) 720 for implementing the system 100. The executable instructions for a process for maintaining data records 734 may include instructions executable on the processing unit(s) 720 for implementing the process 600. The other executable instructions 736 may include instructions executable on the processing unit(s) 720 for providing other aspects described herein or services that may be used in conjunction with aspects described herein.

It is to be understood that the arrangement of computing components is quite flexible. Although shown as contained in a single computing device 710, in some examples, processing unit(s) 720 and memory 730 may be provided on different devices in communication with one another. Although the executable instructions 732, 734, and 736 are shown encoded on a same memory 730, it is to be understood that in other examples a different computer readable media may be used and/or the executable instructions may be provided on multiple computer readable media and/or any of the executable instructions may be distributed across multiple physical media devices. The administrative database 103, the data record database 104, database 742, and other data 744 are shown in FIG. 7 in separate electronic storage units also separated from the computing device 710. In other examples, one or more of the data record database 104, database 742, and other data 744 may be stored in the computing device 710, such as in memory 730. In other examples, one or more of the data record database 104, database 742, and other data 744 may be stored together in a device separate from the computing device 710.

Computing device 710 may be implemented using generally any device sufficient to execute the instructions described herein. Computing device 710 may, for example, be implemented using a computer such as a server, desktop, laptop, tablet, or mobile phone. In some examples, computing device 710 may additionally or instead be implemented using one or more virtual machines. The processing unit(s) 720 may be implemented using one or more processors or other circuitry for performing processing tasks described herein. For example, the processing unit(s) may be configured as a central processing unit. The memory 730 may be implemented using any suitable electronically accessible memory, including but not limited to RAM, ROM, Flash, SSD, or hard drives. The administrative database 103, the data record database 104, database 742, and other data 744 may be implemented stored on any suitable electronically accessible memory, including but not limited to RAM, ROM, Flash, SSD, or hard drives. Databases may be used to store some or all of the administrative database 103, the data record database 104, and the other data 744.

From the foregoing it will be appreciated that, although specific embodiments of the invention have been described herein for purposes of illustration, various modifications may be made without deviating from the spirit and scope of the invention.

What is claimed is:

1. An apparatus comprising:
a data record database comprising a plurality of data records, wherein a data record of the data record database comprises data items, wherein each data item comprises a link to a respective master record from a respective data source;
an administrative database comprising a plurality of state records, herein a state record corresponds to the data record of the plurality of data records;
an analysis module configured to retrieve the data record from the data record database and analyze the data record based on a set of definitions associated with the data record, wherein the analysis module is further configured to, in response to detecting an erroneous data item in the data record, update the state record with an analysis record identifying the erroneous data item; and
a conversation module configured to identify a user associated with the data record and to retrieve an individual availability score for each of a plurality of communication channels associated with the user, the conversation module further configured to request information related to the erroneous data item from the user via a communication channel of the plurality of communication channels having a highest availability score.

2. The apparatus of claim 1, further comprising a tracking module configured to retrieve the analysis record and to request information related to the erroneous data item from other data sources and to update the erroneous data item with received data in response to receipt of updated data.

3. The apparatus of claim 2, further comprising a suggestion engine configured to receive the request for information related to the erroneous data item from the other data sources and to query the other data sources for the information.

4. The apparatus of claim 1, further comprising a data module configured to receive updated data from the user via the communication channel and to update the data record with the updated data.

5. The apparatus of claim 4, wherein the data module is further configured to update the state record in response to receipt of the updated data to indicate receipt of the updated data.

6. A non-transitory, computer-readable medium comprising instructions that, when executed by one or more processor units, cause the one or more processor units to:
retrieve a plurality of data records from a data record database;
retrieve a plurality of rules associated with the plurality of data records;
analyze individual data items of the plurality of data records based on the plurality of rules to detect errors;
in response to detection an erroneous data item of a data record of the plurality of data records, identify a user associated with the data record;
retrieve an individual availability score for each of a plurality of communication channels associated with the user; and
request information related to the erroneous data item from the user via a communication channel of the plurality of communication channels having a highest availability score.

7. The non-transitory, computer-readable medium of claim 6, further comprising instructions that cause the one or more processor units to calculate the individual availability score for each of the plurality of communication channels associated with the user.

8. The non-transitory, computer-readable medium of claim 7, wherein the individual availability score for a respective communication channel of the plurality of communication channels is based on at least one of response history using the respective communication channel for a period of time during a work day, a current user status of the respective communication channel for the user, or response history of peers of the user pertaining to the respective communication channel.

9. The non-transitory, computer-readable medium of claim 6, wherein the plurality of communication channels includes at least one of an instant messenger communication channel, email, text, or social media.

10. The non-transitory, computer-readable medium of claim 6, further comprising instructions that cause the one or more processor units to, in response to lack of a response from the user via the communication channel, repeat a request for information related to the erroneous data item from the user via the communication channel.

11. The non-transitory, computer-readable medium of claim 10, further comprising instructions that cause the one or more processor units to, in response to lack of a response from the user via the communication channel after a predetermined number of attempts, repeating a request for information related to the erroneous data item from the user via another communication channel of the plurality of communication channels.

12. A method comprising:
retrieving a plurality of data records from a data record database;
retrieving a plurality of rules associated with the plurality of data records;
analyzing individual data items of the plurality of data records based on the plurality of rules to detect errors;
in response to detection an erroneous data item of a data record of the plurality of data records, identifying a user associated with the data record;
retrieving an individual availability score for each of a plurality of communication channels associated with the user; and
requesting information related to the erroneous data item from the user via a communication channel of the plurality of communication channels having a highest availability score.

13. The method of claim 12, further comprising:
receiving updated data via the communication channel from the user; and
in response to receiving the updated data, updating the erroneous data item with the updated data.

14. The method of claim 13, wherein updating the erroneous data item comprises updating the erroneous data item in a master record, wherein the data record of the data record database includes a reference to the master record in a data source.

15. The method of claim 14, further comprising:
in response to detection a second erroneous data item of the data record, requesting information related to the second erroneous data item from the user via the communication channel; and
in response to receiving second updated data from the user, updating the erroneous data item in a second master record, wherein the data record of the data record database points to the second master record in a second data source that is different than the data source.

16. The method of claim 13, further comprising, prior to updating the erroneous data item with the updated data:
requesting approval of the updated data from an approver; and
in response to receiving approval from the approver, updating the erroneous data item with the updated data.

17. The method of claim 16, further comprising:
determining an approver score for each of a plurality of possible approvers; and
selecting the approver from the plurality of possible approvers based on the approver score.

18. The method of claim 12, further comprising calculating the individual availability score for each of the plurality of communication channels associated with the user.

19. The method of claim 18, wherein calculation of the individual availability score for a respective communication channel of the plurality of communication channels is based on at least one of response history using the respective communication channel for a period of time during a work day, a current user status of the respective communication channel for the user, or response history of peers of the user pertaining to the respective communication channel.

20. The method of claim 12, wherein the plurality of communication channels includes at least one of instant message, email, text, or social media.

21. The method of claim 12, further comprising, in response to lack of a response from the user via the communication channel, repeating a request for information related to the erroneous data item from the user via the communication channel.

22. The method of claim 21, further comprising, in response to lack of a response from the user via the communication channel after a predetermined number of attempts, repeating a request for information related to the erroneous data item from the user via another communication channel of the plurality of communication channels.
